(19) United States
(12) Patent Application Publication
(10) Pub. No.: US 2018/0330368 A1
(43) Pub. Date: Nov. 15, 2018

(54) SECURE AUTHENTICATED PASSWORDLESS COMMUNICATIONS BETWEEN NETWORKED DEVICES

(71) Applicant: Circle Media Labs Inc., Portland, OR (US)

(72) Inventors: Ted Frank Slupesky, Portland, OR (US); Tiebing Zhang, Cypress, CA (US)

(21) Appl. No.: 15/592,492

(22) Filed: May 11, 2017

(51) Int. Cl. G06Q 20/38; H04L 29/08; H04L 29/06; H04L 9/08

(52) U.S. Cl. CPC G06Q 20/3823; H04L 67/10; H04L 67/42; H04L 67/146; H04L 61/6022; H04L 63/083; G06Q 20/38215; H04L 9/0869; H04L 63/166

(57) ABSTRACT

Methods of secure authenticated passwordless communication executed by a resource client device include (a) receiving an alternate address from a user, (b) sending a registration request to a resource server, (c) receiving from the user a passcode, (d) sending a verification request to the resource server, and (e) receiving from the resource server an access token. The alternate address is an address to communicate with the user via an alternate communication channel. The registration request includes the alternate address and a unique client device identifier associated with the resource client device. The passcode is generated by the resource server and sent to the user at the alternate address via the alternate communication channel. The verification request includes the passcode. The access token is received after sending the verification request. The resource client device may use the access token in future resource requests to the resource server.

### FIELD

The present disclosure relates to security for communications between networked devices.

### BACKGROUND

Secure communications between local devices and remote servers may protect the device and/or the remote server from abuse or compromise. For example, a forged identity may be used to access personal information stored, or accessible, by the local device and/or the remote server. In particular for local devices that are always on, relatively autonomous, and/or that provide personal services for a user (e.g., devices that are part of the Internet of Things), compromised security could provide direct access to the user and/or may not be recognized immediately by the user.

Typically, a remote server that provides protected resources (a resource server) generally restricts access to the resources by an access control mechanism such as user credentials (i.e., user name and password). To provide user credentials, a resource client device (a device that consumes resources of the remote server) will request the credentials from the user each time access to the protected resource is desired or the resource consuming device will store the user credentials. Repeatedly requesting the user credentials from the user may inconvenience the user with frequent requests or may be impractical if the device does not have access to the user when the resources are desired. Storing the user credentials on the device may permit an attacker to access the user credentials by compromising the device. Further, user credentials typically provide rather coarse access control to resources, generally permitting all user access rights together. Hence, if user credentials are compromised, all rights may be compromised together.

As another type of access control, a remote server may permit access to protected resources if the resource client device supplies an agreed access key with a request to access resources. The access key may be derived from user credentials or supplied by the remote sever in response to valid user credentials. Such a procedure relies on the user supplying user credentials. The access key may be provided without relying on user credentials. For example, the operator of the remote server may supply the key to applications developers. The developed applications, and/or the corresponding devices with the application installed, typically embed the access key within the application and/or corresponding device. Distribution of the application and/or device to users may present an opportunity for analysis of the application code and/or device memory, and discernment of the access key, thus, potentially compromising the access key. Additionally, presentation of the access key by a device to the remote server does not indicate that the user of the device is an authorized user of the resources of the remote server.

As yet another type of access control, a secure connection may be established with the TLS (Transport Layer Security) protocol. The TLS protocol is a protocol of the Internet protocol suite that provides a secure communication channel over a computer network. Data transmitted with the TLS protocol is encrypted using a shared encryption key and at least one of the communicating parties is authenticated. If both communicating parties are authenticated with public-key certificates (e.g., through certificate authorities), then each of the parties has assurance that the other party is authentic (the intended party). For user devices and user-associated devices (e.g., personal devices and devices that are part of the Internet of Things), providing public-key certificates for each device may be impractical. Hence, for communication to remote servers, only the remote server is typically authenticated for TLS communication. The TLS protocol is a part of the HTTPS protocol (Hypertext Transfer Protocol (HTTP) Secure).

### SUMMARY

Secure authenticated passwordless communication of the present disclosure includes communication between a resource client device and a resource server. Methods executed by the resource client device may include (a) receiving an alternate address from a user via a first communication channel, (b) sending a registration request via a second communication channel to the resource server, (c) receiving from the user via the first communication channel a passcode, (d) sending a verification request via the second communication channel to the resource server, and (e) receiving from the resource server an access token. The alternate address is an address to communicate with the user via an alternate communication channel. The registration request includes the alternate address and a unique client device identifier associated with the resource client device. The passcode is generated by the resource server and sent to the user at the alternate address via the alternate communication channel. The verification request includes the passcode. The access token is received after sending the verification request. The resource client device may use the access token in future resource requests to the resource server.

Methods executed by the resource server may include (a) receiving the registration request from the resource client device via the second communication channel, (b) sending the passcode to the user at the alternate address via the alternate communication channel, (c) receiving the verification request via the second communication channel from the resource client device, (d) associating the access token with the unique client device identifier, and (e) sending the access token to the resource client device via the second communication channel (after receiving the verification request).

### BRIEF DESCRIPTION OF THE DRAWINGS

FIG. 1 is a schematic representation of a context in which a resource client device and a resource server interact according to the present disclosure.

FIG. 2 is a message flow diagram illustrating a registration method according to the present disclosure.

FIG. 3 is a message flow diagram illustrating a supplemental registration method according to the present disclosure.

FIG. 4 is a message flow diagram illustrating a direct registration method according to the present disclosure.

FIG. 5 is a message flow diagram illustrating a token refresh method according to the present disclosure.

FIG. 6 is a schematic representation of a computing system according to the present disclosure.

### DESCRIPTION

Secure authenticated passwordless communication of the present disclosure involves authenticating a local device's connection to a user and using a dynamic access token to identify authenticated devices. The user does not need to supply user credentials to the local device or a remote resource server. The resource server supplies a passcode to the user via an alternate communication channel (such as through a text message or in-app communication), the user provides the passcode to the local device, the local device sends the passcode to the remote resource server (through a network communication channel), and the resource server provides an access token to the local device. In future resource requests from the local device, the local device supplies the access token to the resource server to identify the local device as authenticated. Local devices may interact with the user through a user's personal device (e.g., a smart phone), a configuration that may be useful for local devices that have limited to no direct user controls.

The resource server may interact with many local devices (also known as resource client devices). For each local device, the resource server associates the supplied access token with the local device, e.g., by maintaining a list and/or database of authenticated devices and the associated access tokens. The scope of access provided by each access token may be limited to just the associated resource client device and may be limited in time (e.g., one week) and/or use (e.g., one time use). Hence, if the access token of one resource client device is compromised, the other resource client devices may not be affected.

By authenticating the resource client devices (local devices) according to the present disclosure, the resource server (remote server) and/or the resource client devices may operate and/or communicate in a potentially untrusted (e.g., uncontrolled) environment (e.g., through the Internet) and/or with potentially untrusted devices (e.g., uncontrolled user devices such as smart phones).

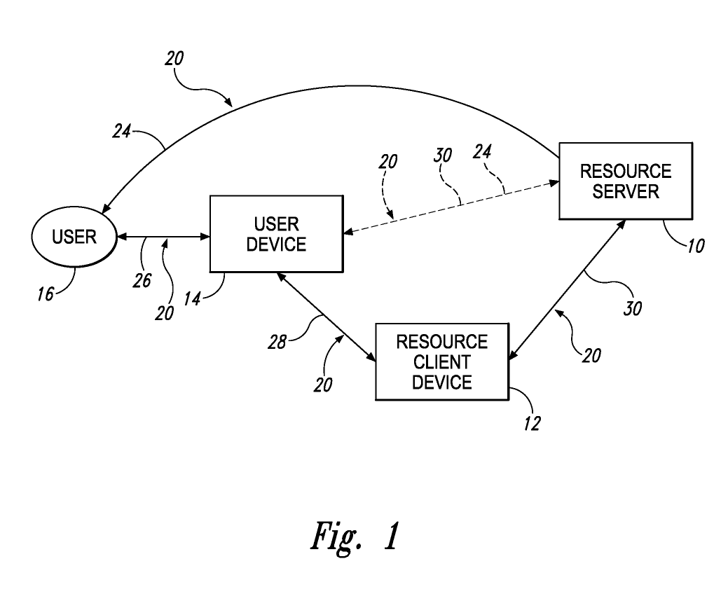

FIGS. 1-6 illustrate systems and methods for secure authenticated passwordless communication between networked devices. In general, in the drawings, elements that are likely to be included in a given embodiment are illustrated in solid lines, while elements that are optional or alternatives are illustrated in dashed lines. However, elements that are illustrated in solid lines are not essential to all embodiments of the present disclosure, and an element shown in solid lines may be omitted from a particular embodiment without departing from the scope of the present disclosure. Elements that serve a similar, or at least substantially similar, purpose are labelled with numbers consistent among the figures. Like numbers in each of the figures, and the corresponding elements, may not be discussed in detail herein with reference to each of the figures. Similarly, all elements may not be labelled or shown in each of the figures, but reference numerals associated therewith may be used for consistency. Elements, components, and/or features that are discussed with reference to one or more of the figures may be included in and/or used with any of the figures without departing from the scope of the present disclosure.

FIG. 1 schematically represents an example of a computing context for secure authenticated passwordless communications. A resource server 10 (also referred to as a remote server) is a network-connected computing device that may interact with other computing devices via a communication channel 20 that is a network communication channel 30 (e.g., an Internet link and/or a wide-area network). The resource server 10 offers protected resources (e.g., access to data, services, and/or computation) via the network communication channel 30. The resource server 10 may be accessible and/or addressed via a URI (uniform resource identifier). The resource server 10 may offer resources by responding to requests (also referred to as calls) from a resource client device 12 (a consumer of resources of the resource server 10). The protocol to request and provide resources from the resource server 10 may be an API (application programming interface). The resource server 10 may implement a REST (representational state transfer) software architecture and provide access to resources through a REST API. Typically, a REST API is an HTTP or HTTPS interface with the resource server 10.

A network-connected computing device is an electronic device configured to connect to and to communicate via a computing network (i.e., the network communication channel 30, such as an Internet link or a wide-area network). A network-connected computing device may physically and/or logically connect/disconnect (or be physically or logically connected/disconnected) from the computing network. The computing network may be a network employing one or more protocols of the Internet protocol suite. An Internet network and an Internet communication channel are respectively a computer network and a network communication channel 30 that employ one or more protocols of the Internet protocol suite. The Internet protocol suite includes application layer protocols, transport layer protocols, internet layer protocols, and link layer protocols. Example protocols of the Internet protocol suite include Transmission Control Protocol (TCP), User Datagram Protocol (UDP), Internet Protocol (IP), Internet Protocol Security (IPsec) protocol, and Transport Layer Security (TLS) protocol. The “Internet” as an adjective may be referred to as “TCP/IP,” which does not indicate that TCP or IP is required. For example, the TCP/IP suite is the Internet protocol suite, the TCP/IP network is the Internet network, and the TCP/IP communication channel is the Internet communication channel.

The resource server 10 may be a distributed computing system that includes an affiliated group of computing devices and/or virtual computing devices (e.g., a virtual machine). The different computing devices may share tasks (e.g., for load balancing). Some or all of the different computing devices may be dedicated to providing a subset of the resource server's resources. For example, tasks such as registration of resource client devices 12, purchasing of services, management of access tokens, and servicing API calls may be performed by different subsets of the affiliated group. Dedicated computing devices may be referred to by the computing device's primary function(s), e.g., a registration server, an access token server, etc.

The resource client device 12 (also referred to as a client device and/or a local device) is a network-connected computing device that is configured to consume resources of the resource server 10. Examples of resource client devices 12 include televisions, gaming systems, cameras, household appliances, medical devices, networking appliances, smart phones, vehicles, and building infrastructure.

The resource client device 12 is configured to interact with the resource server 10 and a user 16 (directly or indirectly). The user interaction may be by physical interaction with the user 16 in which the user operates inputs (e.g., a keypad, controls, a touchscreen, etc.) and/or reviews outputs (e.g., a display, a touchscreen, etc.). Additionally or alternatively, the user interaction with the resource client device 12 may be via a user device 14. The communication channel 20 between the user 16 and the user device 14 (or between the user 16 and the resource client device 12, when present) is a physical communication channel 26. The physical communication channel 26 may include contact communication (e.g., touch and/or movement) between the user 16 and the device (i.e., the resource client device 12 and/or the user device 14) and may include non-contact communication (e.g., voice, sound, gestures, and/or images).

The user device 14 is an electronic device and/or a computing device that is associated with the user 16 and/or controlled by the user 16. For example, the user device 14 may be a personal device such as a smart phone, a cell phone, a smart watch, a wearable device, a mobile device, a remote control, a tablet computer, and/or a personal computer. In particular for user devices 14 that have general purpose computing capabilities, the user device 14 may host, store, and/or execute a control application that interacts with the user 16 through the user device 14 and interacts with the resource client device 12 through the user device 14.

The user device 14 may interact with the resource client device 12 via the communication channel 20 that is a local communication channel 28. The user device 14 may interact with the resource server 10 indirectly via interaction with the resource client device 12 and/or may interact directly (e.g., via an alternate communication channel 24 and/or via the network communication channel 30).

A local communication channel 28 is a short-range electronic communication channel and may be a wired communication channel, a direct wired communication channel, or a wireless communication channel. Examples of local communication channels 28 include a local-area network, a personal-area network, and a peer-to-peer network. Examples of protocols for communication via the local communication channel 28 include TPC/IP, Bluetooth protocol (Bluetooth Special Interest Group), and/or Near Field Communication (NFC) protocol (NFC Forum).

The network communication channel 30, the local communication channel 28, and the alternate communication channel 24 may each independently be configured for secure communications. Secure communications are characterized by a difficulty of eavesdropping, i.e., monitoring the communication by a third party (not one of the intended recipients), and/or by a difficulty of forging, i.e., a third party sending communications as though sent by one of the communicating parties. Secure communication may be achieved through (and eavesdropping and/or forging may be difficult because of) data encryption and/or physical security. Generally, physical security is difficult with the network communication channel 30 because much of the network may be controlled by unknown parties. If the network communication channel 30 is secure, it is typically because the network communication channel 30 employs encryption. Similarly, the alternate communication channel 24 may employ encryption in part because physical security of the alternate communication channel 24 is difficult or impractical. Generally, physical security is easier with the local communication channel 28 because the network is localized and generally under the control of the user 16 or known parties. Physical security, such as short-range wireless signals used in the Bluetooth protocol or the NFC protocol, may be sufficient security for the local communication channel 28.

Encryption in any communication channel 20 generally employs a cryptographic key used to encrypt messages transmitted through the communication channel 20. Cryptosystems may employ symmetric keys (also known as shared secret cryptosystems) or asymmetric keys (also known as public key cryptosystems). With symmetric keys, the same cryptographic key (or simply related keys) is used to encrypt and decrypt messages. Symmetric keys may be referred to as shared secret keys. With asymmetric keys, one cryptographic key is used to encrypt and another cryptographic key is used to decrypt. Asymmetric keys may be referred to as public-private key pairs. Generally, symmetric cryptosystems are faster in execution and asymmetric cryptosystems are more secure. An example of a symmetric cryptosystem is AES (Advanced Encryption Standard). Examples of asymmetric cryptosystems include RSA (Rivest-Shamir-Adleman) and ECC (Elliptic Curve Cryptography).

In addition or alternate to data encryption, the communication channels 20 may permit authentication of at least one of the communicating parties. Authentication may involve a digital signature using the private key of a public-private key pair. A digital signature for authentication will incorporate at least part of the message being signed so that the signature cannot be used out of context (apart from the digitally signed message). The digital signature may be verified by successful decoding with the public key of the public-private key pair. If the public key is associated with the signing/sending party (e.g., by a certificate authority), the digitally signed message may be authenticated as from the signing/sending party. Digital signatures are used in TLS to authenticate at least one of the communicating parties.

The resource client device 12 generally does not have a public or third-party authentication mechanism established while the resource server 10 generally does have a public or third-party authentication mechanism established. Hence, the resource client device 12 may verify the authenticity of the resource server 10, but the resource server 10 may not verify the authenticity of the resource client device 12. The resource server 10 uses the methods of the present disclosure to establish the authenticity of the resource client device 12 and potentially upstream devices such as the user device 14.

The communication channels 20 between the resource server 10, the resource client device 12, and/or the user device 14 may be established by connecting the endpoints (i.e., two of the resource server 10, the resource client device 12, and the user device 14) in a wired or wireless fashion according to the communication protocol (e.g., TCP/IP, Bluetooth protocol, or NFC protocol). The endpoints may establish the communication channel 20 in response to connection of the endpoints. The endpoints may establish the parameters of the communication channel 20 and/or future connections. For example, the endpoints may be paired according to the communication protocol (e.g., by Bluetooth pairing) such that the endpoints may automatically connect ad hoc and/or without user intervention.

The resource server 10 also is configured to communicate with the user 16 via the communication channel 20 that is the alternate communication channel 24, i.e., a communication channel 20 that may send messages to the user 16 without connection or influence of the resource client device 12 and optionally without connection or influence of the user device 14. The alternate communication channel 24 may be referred to as an out-of-band communication channel. Examples of the alternate communication channel 24 include a text message protocol (e.g., SMS (short message service) protocol, MMS (multimedia messaging service) protocol), an email protocol, an instant messaging protocol (e.g., Signal Protocol (Open Whisper Systems)), a telephony protocol, a computer network protocol, and an application-specific protocol. For example, a message delivered via the alternate communication channel may be a text message (SMS or MMS message), a multimedia message (MMS message), an email, an instant message (e.g., a WhatsApp message (Facebook), a Snapchat message (Snap), or an iMessage message (Apple)), a voice message, or a phone call.

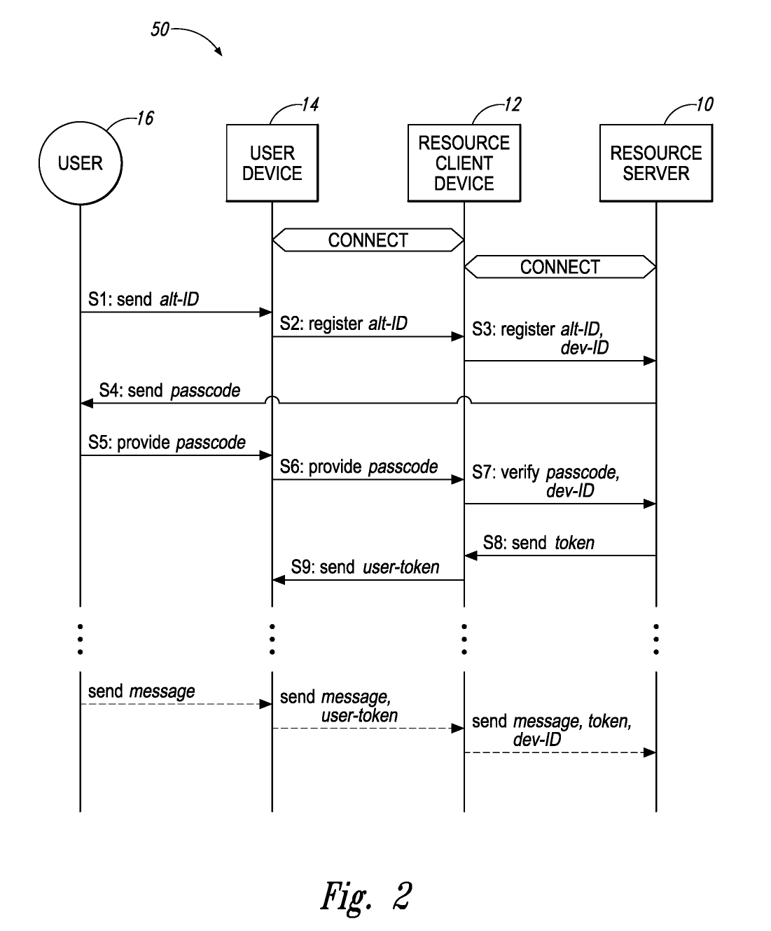

FIG. 2 illustrates an example of a registration method 50 of registering the resource client device 12 and/or the user device 14 with the resource server 10. The registration method 50 includes verifying communication with the user 16 and supplying an access token from the resource server 10 to the resource client device 12. In the registration method 50, the resource server 10, the resource client device 12, the user device 14, and the user 16 are situated in the computing context illustrated in FIG. 1.

Generally, the registration method 50 includes (a) receiving, from the user 16, an alternate address to communicate with the user via the alternate communication channel 24, (b) sending a registration request from the resource client device 12 to the resource server 10, (c) sending a passcode from the resource server 10 to the user 16, (d) relaying the passcode from the user 16 to the resource client device 12 and then to the resource server 10, and (e) sending an access token from the resource server 10 to the resource client device 12. Completion of the registration method 50 authenticates that the resource client device 12 and the user device 14 interact with the same user 16 who is accessible via the alternate communication channel 24 at the alternate address. Upon authentication of the resource client device 12 and user device 14, the resource server 10 will provide resources to the resource client device 12, and the resource client device 12 may permit management by the user device 14.

In the illustrative protocol shown in the message flow diagram of FIG. 2, the user 16 sends (at S1) an alternate address (alt-ID) to the user device 14. The alternate address is an address or identifier that may be used to communicate with the user 16 via the alternate communication channel 24. For example, the alternate address may be the user's phone number, email address, or URI. The user 16 provides his or her alternate address via the physical communication channel 26 (i.e., by physical interaction with the user device 14). The alternate address supplied by the user 16 may be implicit. For example, the use of the user device 14 by the user 16 to contact the resource client device 12 and/or the resource server 10 may designate the user device 14 as the endpoint of the alternate communication channel 24.

The user 16 may send the alternate address to the user device 14 in response to a prompt and/or message to the user 16 from one of the devices described herein, i.e., the user device 14, the resource client device 12, and/or the resource server 10. The prompt and/or message from the device may be via the physical communication channel 26 or, if the device has contact information for the user 16, via the alternate communication channel 24.

The user device 14 receives the alternate address sent by the user 16. The user device 14 may store the alternate address for later reference, verification of the user's identity, and/or for use in future registration requests (e.g., refresh and/or retry messages).

The user device 14 may serve as a contact mechanism for the user 16 via the alternate communication channel 24 (e.g., the user device 14 is a smart phone and the alternate communication channel 24 is a text message communication, or the user 16 operates an application (e.g., an app or a web browser) on the user device 14 that communicates directly or indirectly with the resource server 10). The user device 14 may discern the alternate address without intervention of the user 16 or upon authorization of the user 16 without the user 16 explicitly sending the alternate address to the user device 14.

In response to receiving the alternate address (or otherwise discerning the alternate address), the user device 14 requests registration (at S2) from the resource client device 12 by sending a registration request message that includes (explicitly or implicitly) the alternate address. In some embodiments, the user device 12 may request registration (at S2) directly from the resource server 10 using the alternate communication channel 24 between the user device 14 and the resource server 10 (typically the network communication channel 30). For example, the user device 12 may use a web interface to connect to the resource server 10. By communicating with the resource server 10 via the alternate communication channel 24, the user device 14 is at least implicitly providing the alternate address to contact the user device 14. The registration request from the user device 12 to the resource server 10 (directly or indirectly) may lead to a purchase transaction (e.g., to purchase a subscription to use the services of the resource server 10 and/or the resource client device 12) and/or a purchase/use verification (which may include providing details (e.g., a purchase receipt) of a prior purchase of the resource client device 12, service subscription, etc.).

The registration request message from the resource client device 12 may include a unique user device identifier that is specific to the user device 14. The user device 14 may generate and/or retrieve the unique user device identifier. The resource client device 12 may use the unique user device identifier to recognize, index, and/or correlate messages from the same user device 14.

The optional unique user device identifier may include at least a portion that is a unique component associated with the specific user device 14 and that is private to the user device 14. The unique component is not readily identifiable as associated with the specific user device 14 and not readily reproduced by external knowledge of the specific user device 14 (e.g., every possible unique component may not be feasibly enumerated). For example, the unique user device identifier may include all or part of a UUID (universally unique identifier) of a process (e.g., a program, module, or application) of the user device 14. A UUID is a 128 bit number used to identify information in a computer system and may be generated based on the standard published by the Internet Engineering Task Force (RFC 4122). As another example, the unique user device identifier may include a random number selected from a large domain (e.g., a cryptographically-secure random number of 64, 128, 192, 256, 512, or more bits). Generally, the unique component of the unique user device identifier is one or more numbers, one or more character strings, and/or one or more bit strings.

The unique user device identifier may include a portion that is a recognizable component associated with the specific user device 14. The recognizable component may be predictable and/or feasibly enumerable, and may be advertised, broadcast, and/or published by the user device 14. The recognizable component may be all or a portion of an identifier and/or address of the user device 14. For example, the recognizable component may include all or a portion of the MAC (media access control) address or the URI of the user device 14. Generally, the recognizable component of the unique user device identifier is one or more numbers, one or more character strings, and/or one or more bit strings.

The unique user device identifier or the unique component of the unique user device identifier may be used as a cryptographic key to compute a message authentication code for the registration request message and/or future messages. The message authentication code is a short, encoded form of a message (or portion thereof) that may be used to authenticate the message. The message authentication code is similar to a digital signature except that the cryptographic key used for a message authentication code is a symmetric (shared secret) key while the cryptographic key used for a digital signature is part of an asymmetric key pair. To generate the message authentication code, the message or portion thereof is encoded with a cryptographic key (e.g., the unique user device identifier or the unique component of the unique user device identifier) using an algorithm such as a block cipher or a hash. The message authentication code may be identified with the encoding algorithm, e.g., a Cipher-based Message Authentication Code (CMAC; as described in ISO/IEC 9797-1) or a Hash-based Message Authentication Code (HMAC; as described in ISO/IEC 9797-2). The message authentication code may confirm that the message came from the stated sender and/or has not been modified by a third party (e.g., to guard against message tampering and/or man-in-the-middle attacks). If the message authentication code incorporates a time of the message (or message sequence identifier), the message authentication code may confirm that the message is contemporaneous (e.g., to guard against replay attacks).

The user device 14 sends the registration request to the resource client device 12 via the communication channel 20 (e.g., the local communication channel 28) between the user device 14 and the resource client device 12, referred to as a first communication channel. The first communication channel is established between the user device 14 and the resource client device 12 prior to the user device 14 sending the registration request and/or as part of the user device 14 sending the registration request. For example, the first communication channel may be established by connecting the user device 14 and the resource client device 12 by a wired or wireless link before the user device 14 sends the registration request. As another example, the user device 14 and the resource client device 12 may be paired before the user device 14 sends the registration request (i.e., methods 50 may include pairing the user device 14 and the resource client device 12). While the devices are paired, the first communication channel may be automatically established ad hoc and/or without user intervention.

The resource client device 12 receives the registration request message (that includes the alternate address) from the user device 14 and indirectly from the user 16. In response to receiving the registration request message from the user device 14, the resource client device 12 requests registration (at S3) from the resource server 10 by sending a relay registration request message that includes the alternate address. If the user device 14 communicates directly with the resource server 10 (at S2), no relay registration request message may be needed. The relay registration request message may include a unique client device identifier (dev-ID) that is specific to the resource client device 12. The resource server 10 may use the unique client device identifier to recognize, index, and/or correlate messages from the same resource client device 12. Additionally or alternatively, the relay registration request message may include the unique user device identifier and/or a combination of the unique client device identifier and the unique user device identifier. The resource client device 12 may generate and/or retrieve the unique client device identifier and/or the combination of the unique client device identifier and the unique user device identifier.

The unique client device identifier generally is included in the relay registration request message and in further messages from the resource client device 12 to the resource server 10 to indicate the identity of the resource client device 12 to the resource server 10. Additionally or alternatively, the identity of the resource client device 12 may be established at the beginning of a connection or communication session with the resource server 10 (over the communication channel 20). Once the identity of the resource client device 12 is established, further messages to the resource server 10 may not need further (or repeated) identification information during the established connection and/or session.

The unique client device identifier includes at least a portion that is a unique component associated with the specific resource client device 12 and that is private to the resource client device 12. The unique component is not readily identifiable as associated with the specific resource client device 12 and not readily reproduced by external knowledge of the specific resource client device 12 (e.g., every possible unique component may not be feasibly enumerated). For example, the unique client device identifier may include all or part of a UUID of a process (e.g., a program, module, or application) of the resource client device 12. As another example, the unique resource client device identifier may include a random number selected from a large domain (e.g., a cryptographically-secure random number of 64, 128, 192, 256, or 512 bits). Generally, the unique component of the unique client device identifier is one or more numbers, one or more character strings, and/or one or more bit strings.

The unique client device identifier may include a portion that is a recognizable component associated with the specific resource client device 12. The recognizable component may be predictable and/or feasibly enumerable, and may be advertised, broadcast, and/or published by the resource client device 12. The recognizable component may be all or a portion of an identifier and/or address of the resource client device 12. For example, the recognizable component may include all or a portion of the MAC address or the URI of the resource client device 12. Generally, the recognizable component of the unique client device identifier is one or more numbers, one or more character strings, and/or one or more bit strings.

The unique client device identifier, the unique component of the unique client device identifier, the unique user device identifier, the unique component of the unique user device identifier, or a combination of the unique client device identifier and the unique user device identifier may be used as a cryptographic key to compute a message authentication code for the relay registration request message and/or future messages.

The resource client device 12 sends the relay registration request message to the resource server 10 via the communication channel 20 (e.g., the network communication channel 30) between the resource client device 12 and the resource server 10, referred to as a second communication channel. The second communication channel is established between the resource client device 12 and the resource server 10 prior to the resource client device 12 sending the relay registration request message and/or as part of the resource client device 12 sending the relay registration request message. For example, the second communication channel may be established by connecting the resource client device 12 and the resource server 10 by a wired or wireless link before the resource client device 12 sends the relay registration request message. As another example, the resource client device 12 and the resource server 10 may be paired before the resource client device 12 sends the relay registration request message (i.e., methods 50 may include pairing the resource client device 12 and the resource server 10). While the devices are paired, the second communication channel may be automatically established ad hoc and/or without user intervention.

The resource server 10 receives the relay registration request message sent by the resource client device 12. The resource server 10 may store the alternate address (and/or other parameters received with the relay registration request message such as the unique client device identifier and/or the unique user device identifier) for later reference, verification of the user's identity, and/or for use in future registration requests.

The resource server 10 may verify that the resource client device 12 is unregistered and/or unmanaged by any user 16 based upon the contents of the relay registration request message. The resource server 10 may maintain a list and/or a database of managed resource client devices 12 and/or registered users 16. The list and/or database may store data from past interactions with users 16, user devices 14, and/or resource client devices 12. The data in the list and/or database may include alternate addresses of users 16, unique user device identifiers of user devices 14, unique client device identifiers of resource client devices 12, access tokens (as described further herein), and/or parameters characterizing prior contacts (such as date of transactions, time of transactions, session identifiers of transactions, MAC addresses of devices, IP addresses of devices, etc.). The list and/or database may indicate if the resource client device 12 is unregistered and/or unmanaged (e.g., if the resource client device 12 is missing from the list and/or database or the registration is indicated as expired, revoked, or otherwise lapsed). If the resource server 10 determines that the resource client device 12 is registered and/or managed, the resource server 10 may terminate the current registration and/or management prior to continuing with the registration method 50. Termination of the current registration and/or management may include sending a notification of termination to the current user 16 and/or the current user device 14. Termination of the current registration and/or management may include obtaining permission to terminate from the current user 16 and/or the current user device 14.

In response to the resource server 10 receiving the relay registration request message, and/or in response to determining that the resource client device 12 is unregistered and/or unmanaged, the resource server 10 sends (at S4) a passcode (passcode) to the user 16 and/or the user device 14 by sending a passcode message (that indicates the passcode) to the user 16 and/or the user device 14 at the alternate address via the alternate communication channel 24. FIG. 2 illustrates an example of sending (at S4) the passcode message from the resource server 10 to the user 16 that bypasses the user device 14. In some embodiments, the passcode message may be sent to the user device 14 without sending the passcode message to the user 16 (directly from the resource server 10 or indirectly via the user device 14).

The resource server 10 stores the passcode indicated by the passcode message for future verification of the passcode from the user 16 and/or the user device 14. The resource server 10 waits for the user 16 and/or user device 14 to receive the passcode message and to relay the passcode indicated by the passcode message back to the resource server 10 through interaction with the resource client device 12.

The resource server 10 may generate and/or retrieve the passcode and/or passcode message that is to be sent to the user 16 and/or the user device 14. The passcode may be generated based on the unique client device identifier and/or other contents of the relay registration request message but generally does not include any part of the relay registration request message. Using information other than what is included in the relay registration request message inhibits the resource client device 12 from guessing the passcode and circumventing the contact of the user 16 and/or the user device 14 at the alternate address.

The passcode provided to the user 16 and/or the user device 14 may be a textual message, an image, a voice message, a sound, and/or a pattern (e.g., textual, optical, or sonic). The passcode is generally short and/or simple such that the user 16 may readily recognize the passcode and may easily provide the passcode to electronic devices such as the user device 14. For example, the passcode may be a string of less than twenty characters, a group of less than five words, etc. However, in some embodiments, the passcode may be a digital message that may not be recognizable or interpretable by the user 16. Such a digital message (as with other types of passcodes) may be relayed (as described further herein) by the user 16 and/or the user device 14 to the resource client device 12 without interpretation and/or intervention by the user 16.

The passcode may be provided to the user 16 and/or the user device 14 in exact form (in which the passcode message is the passcode to be relayed by the user 16 and/or the user device 14) or in inexact form (in which the user 16 and/or the user device 14 interprets and/or describes the passcode message to relay the passcode). As an example of an exact-form message, an alphanumeric passcode may be sent by the resource server 10 by text messaging to the mobile phone number of the user 16. As an example of an inexact-form message, an alphanumeric passcode may be sent to the user 16 as a CAPTCHA-style image (via multimedia messaging, email, instant messaging, etc.) that represents the alphanumeric passcode. The user 16 may interpret the image to identify the letters, numbers, and/or symbols as the passcode. CAPTCHA is a type of challenge-response test used in computing to determine whether or not the challenged party (the user) is human or machine. An example of a CAPTCHA system is reCAPTCHA by Google. Other types of challenge-response tests may be used in addition or in alternate to a CAPTCHA challenge. For example, the passcode message may prompt the user 16 to describe characteristics of an image (e.g., the row and column of a specific symbol within a grid of symbols). Inexact-form passcode messages and challenge-response tests may inhibit an attacker gaining access to the resource server 10 and/or the resource client device 12 by mimicking the user 16 during registration.

The resource server 10 may define a registration period in which to receive the passcode from the user 16. If the resource server 10 does not receive the passcode from the user within the registration period, the resource server 10 may reject the registration request. If the registration request is rejected by the resource server 10 because a correct passcode was received outside of the registration period, the resource server 10 may initiate a new registration request by communicating with the user 16 (via the alternate communication channel 24) and/or the resource client device 12 (via the communication channel 20 between the resource server 10 and the resource client device 12).

The user 16 may receive the passcode message from the resource server 10, discern the passcode, and provide (at S5) the passcode to the user device 14. If the user device 14 serves as a contact mechanism for the user 16 via the alternate communication channel 24 (and/or if the user device 14 is the end target of the passcode message), the user device 14 may receive the passcode message from the resource server 10, present the passcode message to the user 16, and/or discern the passcode without intervention of the user 16. Thus, the user device 14 may substitute for the user 16 receiving the passcode message and/or the user 16 discerning the passcode, in which case the user 16 may not need to provide the passcode to the user device 14.

In response to receiving the passcode from the user 16 (or otherwise discerning the passcode), the user device 14 provides (at S6) the passcode to the resource client device 12. With the passcode, the user device 14 may provide the unique user device identifier (that was optionally provided during the registration request at S2). The user device 14 provides the passcode to the resource client device 12 via the first communication channel (between the user device 14 and the resource client device 12).

The resource client device 12 receives the passcode from the user device 14 and optionally indirectly from the user 16. In response to receiving the passcode from the user device 14, the resource client device 12 may request verification (at S7) from the resource server 10 by sending a verification message that includes the passcode. The verification message may include the unique client device identifier and/or the unique user device identifier. The resource client device 12 requests verification from the resource server 10 via the second communication channel (between the resource client device 12 and the resource server 10).

The resource server 10 receives the verification message from the resource client device 12. The resource server 10 verifies that the passcode received with the verification message is the same passcode that was indicated by the passcode message sent to the user 16. The resource server 10 may verify that the passcode was received from the expected device (e.g., the resource client device 12 associated with the unique client device identifier, MAC address, etc. that sent the original relay registration request message) and/or received within the expected time (e.g., within the registration period).

If the passcode received by the resource server 10 is verified, the resource server 10 may generate and/or retrieve an access token. The access token is an authentication key to be used by the resource client device 12 to submit resource requests to the resource server 10. The access token may be generated based on the unique client device identifier and/or other contents of the verification message (or the relay request message) but generally does not include any part of the verification message (or prior messages). Using information other than what is sent by the resource client device 12 inhibits the resource client device 12 from guessing the access token and circumventing the contact of the user 16 and/or the user device 14 at the alternate address.

The access token is a unique value associated with the resource client device 12. Each resource client device 12 may have a different access token that is associated with the respective resource client device 12. The access token is not feasibly enumerated and is not readily reproduced by external knowledge of the resource server 10 or the resource client device 12. Generally, the access token is in the form of one or more numbers, one or more character strings, and/or one or more bit strings. The access token typically is a cryptographic key or a number selected from a large domain (e.g., a cryptographically-secure random number of 64, 128, 192, 256, 512, or more bits). The access token may be encoded for ease of transmission and/or data handling, e.g., base64 encoded to permit safe transmission of the access token in an HTTP header. The access token may be in the form of a JSON (JavaScript Object Notation) Web Token (JVVT). Additionally or alternatively, a JVVT may incorporate the access token and other identifying information such as the unique client device identifier and/or the unique user device identifier. The access token may be associated with a validity period during which the access token may be used by the resource client device 12 to submit resource requests to the resource server 10. Outside of the validity period, the access token may be treated as expired, revoked, or otherwise lapsed.

The resource server 10 associates the access token with the specific resource client device 12 that sent the verified passcode (e.g., by associating the access token with the unique client device identifier). The resource server 10 may associate the access token with the specific user device 14 that relayed the passcode to the specific resource client device 12 (e.g., by associating the access token with the unique user device identifier). The resource server 10 may associate the access token with the specific user 16 and/or user device 14 that is accessible at the alternate address via the alternate communication channel 24 (e.g., by associating the access token with the alternate address).

In response to receiving the passcode (in the verification message) from the resource client device 12 and verifying the passcode, the resource server 10 sends (at S8) the access token (token) to the resource client device 12. The resource server 10 sends the access token to the resource client device 12 via the second communication channel (between the resource client device 12 and the resource server 10). Generally, the access token is sent encrypted to prevent unauthorized access to the access token. For example, the second communication channel may employ an encryption protocol (e.g., TLS). As another example, the access token may be sent in a message encrypted by the unique client device identifier, the unique user device identifier, a combination of the unique client device identifier and the unique user device identifier, and/or a cryptographic key derived from the unique client device identifier and/or the unique user device identifier.

The resource client device 12 receives the access token from the resource server 10 and stores the access token for use in future resource requests to the resource server 10. The resource client device 12 may acknowledge receipt of the access token by sending to the resource server 10 an acknowledgement message. The acknowledgement message may include the access token and optionally the unique client device identifier and/or the unique user device identifier. In some embodiments, the resource client device 12 may use the passcode received (at S6), which is received indirectly from the resource server 10, as the access token. The passcode would not need to be verified (at S7) by the resource server 10, though the resource client device 12 may verify the passcode or otherwise confirm receipt of the passcode by sending a message to the resource server 10.

Use of the access token in future communication messages (resource requests and/or other messages such as the acknowledgement message) to the resource server 10 may be as a portion of the communication message (e.g., the access token is transmitted in the body or header of a communication message). Additionally or alternatively, the access token may be used to encrypt the communication message, to digitally sign the communication message, and/or to create a message authentication code to be sent with the communication message. Generally, the access token is sent encrypted (e.g., with TLS) or otherwise obscured (e.g., used as a cryptographic key for encrypting, digital signing, and/or creating a message authentication code) to prevent unauthorized access to the access token.

Once the passcode that was received from the resource client device 12 is verified and the access token is active (i.e., the access token is sent to the resource client device 12 and/or is acknowledged as received by the resource client device 12), the resource server 10 may mark or otherwise indicate that the specific resource client device 12 is registered and/or managed (by the user 16). For example, the resource server 10 may maintain a list and/or database that associates unique client device identifiers with active (and not expired, revoked, or otherwise lapsed) access tokens. A resource client device 12 is registered and/or managed if that resource client device 12 is associated with an active access token.

In response to receiving the access token from the resource server 10, the resource client device 12 may send (at S9) a user access token (user-token) or another form of a registration/verification success message to the user device 14. The optional user access token is an authentication key to be used by the user device 14 to submit messages to the resource client device 12. The user access token is the access token or a token generated and/or retrieved by the resource client device 12. For example, the user access token may be generated based on the access token and/or the unique user device identifier. The user access token generally does not include any part of prior messages from the user device 14. Using information other than what is sent by the user device 14 inhibits the user device 14 from guessing the user access token and circumventing the contact of the user 16 at the alternate address and the verification of the passcode at the resource server 10.

The user access token may be a unique value associated with the resource client device 12 and/or the user device 14. Each user device 14 may have a different user access token or each user device 14 may share the same user access token for one resource client device 12. The user access token has the general attributes of the access token except that the user access token is provided by the resource client device 12 to the user device 14. The user access token may be in a form suitable for the access token (or the same as the access token), may be sent to the user device 14 in a manner suitable to send the access token (or in the same manner), may be used with communication messages from the user device 14 to the resource client device 12 in a manner suitable to use the access token with communication messages from the resource client device 12 to the resource server 10 (or in the same manner).

The resource client device 12 may associate the user access token with the specific user device 14 that sent the passcode that was ultimately verified by the resource server 10. For example, the resource client device 12 may associate the user access token with the unique user device identifier.

The user device 14 may receive the user access token from the resource client device 12 and store the user access token for use in future messages to the resource client device 12. The user device 14 may acknowledge receipt of the user access token by sending to the resource client device 12 an acknowledgement message. The acknowledgement message may include the user access token and optionally the unique user device identifier. Once the user device 14 has received the user access token or other acknowledgement of successful verification of the passcode, the user device 14 is configured to manage the resource client device 12.

As a specific example of the registration method 50, the user 16 may request registration of the resource client device 12 via an app installed on the user's phone (the user device 14). The user 16 may request registration (at S1) from the app. The user 16 does not need to provide the alternate address (alt-ID) to the app. The app identifies the phone number associated with the user device 14 as the alternate address and sends a registration request message (at S2) to the resource client device 12 that includes the user's phone number. At S3, the resource client device 12 sends a relay registration request message to the resource server 10 that includes the user's phone number and the unique client device identifier (dev-ID). The resource server 10 records the unique client device identifier, generates an alphanumeric string as the passcode, and texts (at S4) the passcode to the user's phone number. The user 16 or the user device 14 extracts the passcode from the text message and the user device 14 provides (at S6) the passcode to the resource client device 12. The resource client device 12 requests (at S7) verification of the passcode by the resource server 10. The resource server 10 verifies that the passcode received is the same as the passcode sent and that the passcode matches the unique client device identifier. Upon verification of the passcode received, the resource server 10 generates and sends (at S8) an access token.

As another specific example of the registration method 50, the passcode may be a purchase receipt or data related to a purchase receipt. The purchase receipt may represent purchase of the resource client device 12 and/or a subscription to use the services of the resource server 10 and/or the resource client device 12. For example, the user 16 may request a service subscription for the resource client device 12. The service subscription may include registration of the resource client device 12. In response to the subscription request, the user device 14 (e.g., a tablet computer or a mobile phone) sends (at S2) a registration request to the resource server 10. The alternate address (alt-ID) is the email address of the user 16 or a URI accessed by the user device 14 (e.g., a web page). The resource server 10 recognizes that the resource client device 12 is unregistered and contacts the user device 14 and/or the user 16 to complete a purchase transaction (or other user registration transaction) to begin the subscription. Once the subscription has been purchased (or registered) by the user 16, the resource server 10 sends (at S4) a purchase receipt as the passcode message to the user 16 and/or the user device 14. The purchase receipt is received by the user device 14 and provided (at S6) to the resource client device 12. In some embodiments, the user 16 and/or user device 14 in possession of the purchase receipt may begin the registration method 50 by providing (at S6) the purchase receipt to the resource client device 12.

Following receipt of the purchase receipt by the resource client device 12, the resource client device 12 requests (at S7) verification of the purchase receipt by the resource server 10. The verification request (at S7) includes the unique client device identifier (dev-ID) of the resource client device 12. The user device 14, the resource client device 12, and/or the resource server 10 may extract data from the purchase receipt to send and/or to verify as the passcode. The resource server 10 verifies that the purchase receipt received is the same as the purchase receipt sent (or that the data received as the passcode is derived from the purchase receipt sent). To facilitate verification of the purchase receipt, the purchase receipt may be linked to the user 16, the user device 14, and/or the resource client device 12, for example, in the receipt itself (e.g., by encryption, message authentication code, or digital signature) or by association at the resource server 10. Upon verification of the purchase receipt (or passcode) received, the resource server 10 generates an access token, associates the access token with the unique client device identifier, and sends (at S8) the access token.

Communication messages from the resource client device 12 to the resource server 10 use the access token as described herein and as shown at the bottom of the example in FIG. 2. Upon receipt of a communication message (“send message . . . ” in FIG. 2) from the resource client device 12, the resource server 10 may verify that the access token is valid (i.e., corresponds to the resource client device 12 that sent the communication message and the access token is active (not expired, revoked, or otherwise lapsed)). If the access token for a communication message is not valid, the resource server 10 may not respond to the communication message from the resource client device 12 or may respond with an error message that indicates the invalid access token. Additionally or alternatively, if the invalid access token was invalid because the access token is expired, revoked, or otherwise lapsed, the resource server 10 may initiate a new registration request by communicating with the user 16 (via the alternate communication channel 24) and/or the resource client device 12 (via the second communication channel).

Communication messages from the resource client device 12 to the resource server 10 may be initiated and/or may be in response to communication messages from the user device 14 to the resource client device 12. Communication messages from the user device 14 to the resource client device 12 may use the user access token as described herein. Upon receipt of a communication message from the user device 14, the resource client device 12 may verify that the user access token is valid (i.e., corresponds to the user device 14 that sent the communication message and user access token is active (not expired, revoked, or otherwise lapsed)). If the user access token for a communication message is not valid, the resource client device 12 may not respond to the communication message or may respond with an error message that indicates the invalid access token. Additionally or alternatively, if the invalid user access token was invalid because the user access token is expired, revoked, or otherwise lapsed, the resource client device 12 may initiate a new registration request by communicating with the resource server 10 (via the second communication channel) and/or the user device 14 (via the first communication channel).

The resource server 10 may be configured to limit the duration of validity of the access token and may provide new access tokens automatically or in response to a request from the resource client device 12. For example, the access token may be valid for a defined period, e.g., an hour, a day, 10 days, 90 days, or other suitable period. Additionally or alternatively, the access token may be valid for a defined number of uses (e.g., API calls from the resource client device 12). The defined number of uses may be 1, 3, 10, 100, or other suitable number. If the access token is invalid (e.g., outside of the validity period or beyond the number of uses), the access token may not be successfully used by the resource client device 12 to access resources from the resource server 10 (and/or other servers that rely on the validity of the access token).

Use of limited-validity access tokens may mitigate a potential security breach that may be achieved by compromising the resource client device 12. For example, a valid access token and associated client device identifier may be copied from the resource client device 12. A device that uses the copied access token and client device identifier would have access limited to the duration of validity of the copied access token. If a new access token may only be obtained by presenting a valid access token, only one of the original resource client device 12 or the device that has the copied access token would be able to obtain a new access token.

As an example of using limited-validity access tokens, access tokens may be valid only for a single API call. A valid API call from the resource client device 12 with a valid access token would cause the access token to expire. The resource server 10 could respond to the expired access token and/or the valid API call with a new access token for use by the resource client device 12 in the next API call. To ensure that the new access token was received by the resource client device 12, an acknowledgment of the new access token may be required before processing the API call. If the new access token is not acknowledged, the API call may be rejected and the original access token may remain valid to attempt another API call.

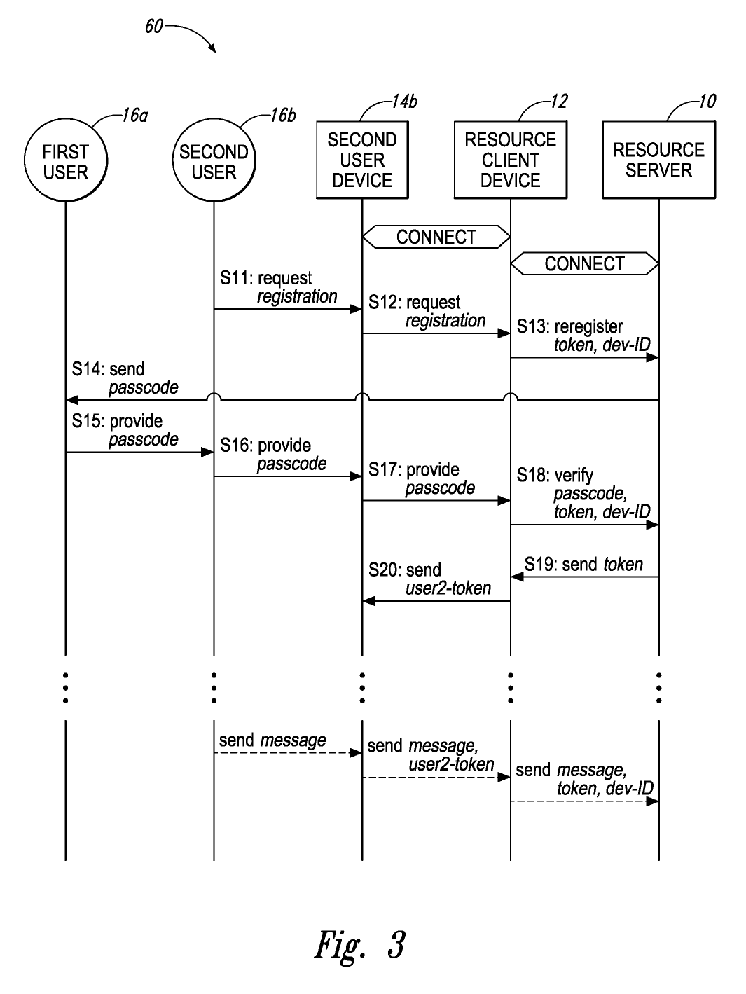

FIG. 3 illustrates an example of a supplemental registration method 60 (also referred to as a second user registration method). The resource client device 12 generally communicates with, and is managed by, one or a few user devices 14. Once one user device 14 is used to register the resource client device 12 (e.g., with the registration method 50), the resource client device 12 is registered and/or managed. A second user device 14b may be configured to manage the resource client device 12 along with the original user device 14. The supplemental registration method 60 follows the general scheme of the registration method 50 except that the second user device 14b may not change the alternate address of the original user 16 (labelled a first user 16a in FIG. 3) established during the registration method 50. The second user device 14b may be associated with a second user 16b or the first user 16a. Hence, the supplemental registration method 60 may be used to permit the first user 16a to manage the resource client device 12 with more than one user device 14 and/or may be used to permit the first user 16a and the second user 16b to manage the resource client device 12 with different user devices 14.

Generally, the supplemental registration method 60 includes (a) receiving, from the first user 16a or the second user 16b, a supplemental registration request, (b) relaying the supplemental registration request from the second user device 14b to the resource client device 12 and then to the resource server 10, (c) sending a passcode from the resource server 10 to the first user 16a (and/or the (first) user device 14) at the registered alternate address of the first user 16a, (d) relaying the passcode from the first user 16a (and/or the (first) user device 14) to the second user 16b (if present), to the second user device 14b, to the resource client device 12, and then to the resource server 10, and (e) sending acknowledgement of passcode verification from the resource server 10 to the resource client device 12 to permit management of the resource client device 12 by the second user device 14b.

In the illustrative protocol shown in the message flow diagram of FIG. 3, the second user 16b requests (at S11) a supplemental registration of the second user device 14b. The supplemental registration request may include an alternate address to contact the second user 16b and/or may be performed in the manner of sending the alternate address in the registration method 50 (at S1). Instead of the second user 16b requesting (at S11) the supplemental registration, the first user 16a may request the supplemental registration of the second user device 14b.

The second user 16b (or the first user 16a) may request the supplemental registration in response to a prompt and/or message to the second user 16b (or the first user 16a) from one of the devices described herein, i.e., the second user device 14b, the resource client device 12, and/or the resource server 10. The prompt and/or message from the device may be via the physical communication channel 26 or, if the device has contact information for the first user 16a or the second user 16b, via the alternate communication channel 24 for the corresponding user 16.

The second user device 14b receives the supplemental registration request sent by the second user 16b (or first user 16a). If the supplemental registration request includes the alternate address of the second user 16b, the second user device 14b may store the alternate address as may be performed in registration method 50.

In response to receiving the supplemental registration request, the second user device 14b requests supplemental registration (at S12) from the resource client device 12 by sending a supplemental registration request message. The supplemental registration request message may include the alternate address of the second user 16b and/or a unique second user device identifier that is specific to the second user device 14b. The unique second user device identifier of the second user device 14b is like the unique user device identifier of the (first) user device 14 and may be formed, manipulated, and/or process analogously.

The second user device 14b is situated in a computing context analogous to the (first) user device 14. The second user device 14b sends the supplemental registration request message to the resource client device 12 via the communication channel 20 (e.g., the local communication channel 28) between the second user device 14b and the resource client device 12, referred to as a first communication channel of the supplemental registration method 60. The first communication channel of the supplemental registration method 60 is established between the second user device 14b and the resource client device 12 prior to the second user device 14b sending the supplement registration request message and/or as part of the second user device 14b sending the supplemental registration request message. The first communication channel of the supplemental registration method 60 may be established and/or used in an analogous manner to the first communication channel of the registration method 50.

The resource client device 12 receives the supplemental registration request message from the second user device 14b. In response to receiving the supplemental registration request message from the second user device 14b, the resource client device 12 requests supplemental registration (at S13) from the resource server 10 by sending a relay supplemental registration request message (which may include the alternate address of the second user 16b). The relay supplemental registration request message includes the access token and is validated as would be for other communication messages between the resource client device 12 and the resource server 10 as described herein. Once the access token is validated, requesting supplemental registration (at S13) from the resource server 10 may be performed in the manner of requesting registration in the registration method 50 (at S3).

The resource server 10 receives the relay supplemental registration request message sent by the resource client device 12, processes the message, and responds by sending (at S14) the passcode in the manner of the analogous steps of the registration method 50. The resource server 10 may verify that the resource client device 12 is registered and may determine the alternate address of the first (original) user 16a who participated in the prior registration. If the resource client device 12 is unregistered and/or unmanaged, and/or if the alternate address of the first user 16a is unavailable, the resource server 10 may terminate the supplemental registration method 60. Provided that the resource server 10 has sufficient information to proceed, the resource server 10 may proceed with the registration method 50 using the second user 16b (or the first user 16a if the only user 16) as the user 16, the second user device 14b as the user device 14, and, if the second user 16b is present, the alternate address of the second user 16b as the alternate address (of the only user 16).

In the registration method 50, the passcode is sent to the user 16 (the first user 16a of the supplemental registration method 60) who controls and/or is associated with the (first) user device 14. In the supplemental registration method 60, the passcode is sent to the first user 16a who may or may not control and/or be associated with the second user device 14b.

If the second user 16b is present, the first user 16a may provide (at S15) the passcode to the second user 16b. The steps of providing (at S16) the passcode from the second user 16b to the second user device 14b and providing (at S17) the passcode from the second user device 14b to the resource client device 12 are performed in analog to the providing steps (at S5 and S6) of the registration method 50.

In response to receiving the passcode from the second user device 14b, the resource client device 12 requests verification (at S18) from the resource server 10 by sending a verification message that includes the passcode and the access token established with the registration method 50. The access token is validated as would be for other communication methods between the resource client device 12 and the resource server 10 as described herein. Once the access token is validated, requesting verification (at S18) from the resource server 10 may be performed in the manner of verification in the registration method 50 (at S7).

If the access token and the passcode are verified, the resource server 10 sends (at S19) an acceptance message to the resource client device 12. The acceptance message indicates that the interaction of the first user 16a has been successfully verified. The acceptance message may include the established access token. The resource server 10 may send (at S19) the acceptance message in a manner analogous to sending the access token in the registration method 50 (at S8).

In response to receiving the acceptance message from the resource server 10, the resource client device 12 may send (at S20) a second user access token (user2-token) to the second user device 14b. The optional second user access token is an authentication key to be used by the second user device 14 to submit messages to the resource client device 12. The second user access token is the access token or a token generated and/or retrieved by the resource client device 12, in analog to the user access token. The second user access token may be the same as the user access token.

The resource client device 12 may associate the second user access token with the specific second user device 14b that sent the passcode ultimately verified by the resource server 10. For example, the resource client device 12 may associate the second user access token with the unique second user device identifier.

The second user device 14b may receive the second user access token from the resource client device 12 and store the second user access token for use in future messages to the resource client device 12. The second user device 14b may acknowledge receipt of the second user access token by sending to the resource client device 12 an acknowledgement message. The acknowledgement message may include the second user access token and optionally the unique second user device identifier. Once the second user device 14b has received the second user access token or other acknowledgement of successful verification of the passcode, the second user device 14b and the (first) user device 14 both are configured to manage the resource client device 12.

The resource client device 12 may register (and/or accept management by) the second user device 14b without utilizing the resource server 10. In such case, the supplemental registration method 60 may be followed by substituting the resource client device 12 for the resource server 10. For example, the registration request (at S12) may prompt the resource client device 12 to send (at S14) the passcode or other message to the first user 16a and/or the (first) user device 14 (not shown).

Communication messages from the resource client device 12 to the resource server 10 use the access token as described herein with respect to communication messages after successful registration. Communication messages from the second user device 14b to the resource client device 12 may use the second user access token as described herein with respect to the user device 14, the user access token, and communication messages after successful registration. Communications from the resource client device 12 to the resource server 10 may or may not distinguish and/or identify which user or user device prompted the communication (if any).

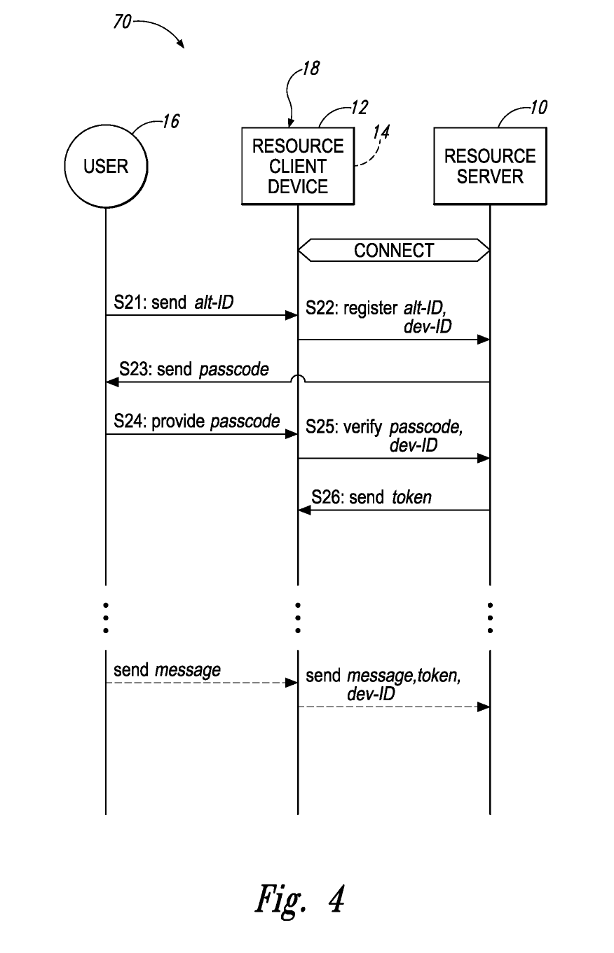

FIG. 4 illustrates an example of a direct registration method 70 that is similar to the registration method 50 except that the user 16 interacts directly with a control device 18. The control device 18 may be the resource client device 12, a combined user device 14 and resource client device 12, or the user device 14. Hence, the direct registration method 70 provides for registration of a resource client device 12 that interacts directly with the user 16 and/or for registration of a user device 14 that interacts with the resource server 10 without using the resource client device 12 as an intermediary.

In the illustrative protocol shown in the message flow diagram of FIG. 4, the user 16 sends (at S21) the alternate address of the user 16 to the control device 18 in analog to sending the alternate address of the user 16 to the user device 14 in the registration method 50 (at S1). The control device 18 acts as the user device 14 to receive the alternate address and acts as the resource client device 12 to request registration (at S22) by sending a registration request message in analog with the registration method 50 (at S2 and S3).

The resource server 10 processes the registration request message of S22 and sends (at S23) the passcode to the user 16 in the same manner as with the registration method 50 (e.g., at S4).

The user 16 provides (at S24) the passcode to the control device 18 in analog to providing the passcode to the user device 14 in the registration method 50 (at S5). The control device 18 acts as the user device 14 to receive the passcode and acts as the resource client device 12 to request verification (at S25) by sending a verification message in analog with the registration method 50 (at S6 and S7).

The resource server 10 processes the verification message of S25 and sends (at S26) the access token to the control device 18 in analog with the registration method 50 (at S8). The control device 18 acts as the resource client device 12 to receive the access token.

Once registered, the control device 18 sends communication messages to the resource server 10 and receives communication messages from the user 16 in the manner of the resource client device 12 and the user device 14, respectively.

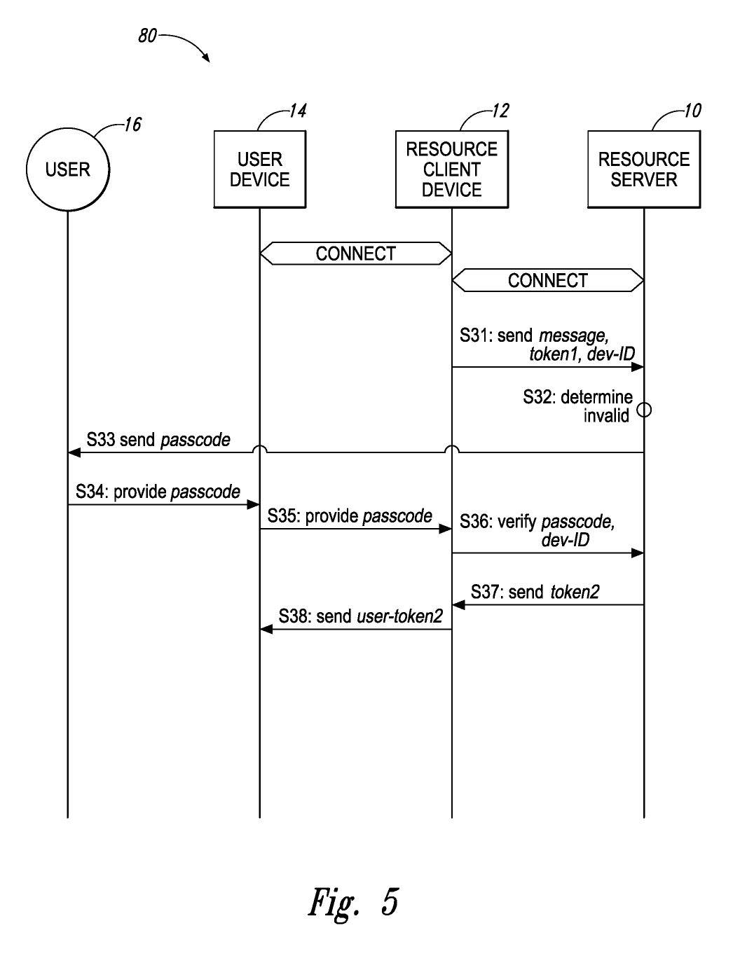

FIG. 5 illustrates an example of a token refresh method 80 that may be used to establish a new access token when an earlier access token is (or is about to become) invalid (e.g., becomes or will become expired, revoked, or otherwise lapsed). The access token may expire automatically after the validity period. Additionally or alternatively, the access token may be revoked by the resource server 10, the resource client device 12, the user device 14, and/or the user 16. The access token may be revoked if the access token is compromised or likely compromised. The access token may be revoked to eliminate the registration associated with the current user 16, to change users, and/or to reset the resource client device 12 to an unregistered and/or unmanaged state.

In the illustrative protocol shown in the message flow diagram of FIG. 5, the resource client device 12 sends (at S31) a communication message including the current access token (token1) and the unique client device identifier. In the event that the resource server 10 determines (at S32) that the current access token is invalid or is soon to be invalid, the token refresh method 80 may be invoked. Though in FIG. 5, the token refresh method 80 is initiated by the resource server 10 due to analysis of a communication message, the token refresh method 80 may be initiated through any event that communicates to the resource server 10 that token refresh method 80 should be invoked. For example, the user 16 may request that the current access token be revoked and replaced, the resource client device 12 and/or the resource server 10 may request that the current access token be replaced when the validity period of the current access token is about to expire (e.g., one day before expiration), and/or the resource server 10 may invoke the token refresh method 80 after one or more failed access attempts from the resource client device 12.

Once the token refresh method 80 is invoked, the resource server 10 may cache or temporarily invalidate the current access token if it is otherwise still valid. If the token refresh method 80 is unsuccessful, the current access token may be reinstalled if it remains otherwise valid.

The resource server 10 sends (at S33) the passcode to the user 16, the user 16 provides (at S34) the passcode to the user device 14, the user device 12 provides (at S35) the passcode to the resource client device 12, and the resource client device 12 requests verification (at S36) by sending the verification message. Each of steps S33, S34, S35, and S36 are performed in the same manner described with respect to the registration method 50, except that the passcode of the token refresh method 80 is different than the passcode of the registration method 50 or is generated in a manner highly likely to produce a different passcode (e.g., by random selection from a large domain).

If the passcode received by the resource server 10 in the verification message is verified, the resource server 10 may generate and/or retrieve a replacement access token (token2). The replacement access token is not the same as the current access token (token1). Otherwise, the replacement access token may be generated, processed, and used in the manner of the access token of the registration method 50. If the passcode is not verified, the resource server 10 may reinstall the current access token (if it remains valid), may terminate the token refresh method 80, or may attempt to retry the registration or token refresh methods as described with respect to a passcode that is not verified during the registration method 50

In response to receiving the passcode and verifying the passcode, the resource server 10 sends (at S37) the replacement access token (token2) to the resource client device 12, in analog to the registration method 50 (at S8). The resource client device 12 receives the replacement access token and processes the replacement access token in the same manner as in the registration method 50. The resource client device 12 will use the replacement access token in future communication messages to the resource server 10 instead of the current access token. The resource client device 12 may generate, access, send (at S38), and/or use a replacement user access token (user-token2) in analog to the processing and use in the registration method 50 (e.g., at S9).

In some embodiments, the token refresh method 80 may involve the resource server 10, receiving (at S31) the current access token (token1), determining (at S32) that the current access token is invalid or about to be invalid (e.g., the current access token is a one-time use token), generating and/or retrieving the replacement access token (token2), and sending (at S37) the replacement access token to the resource client device 12. With such a variation of the refresh method 80, the user 16 and/or the user device 14 does not need to participate in the token refresh method 80.

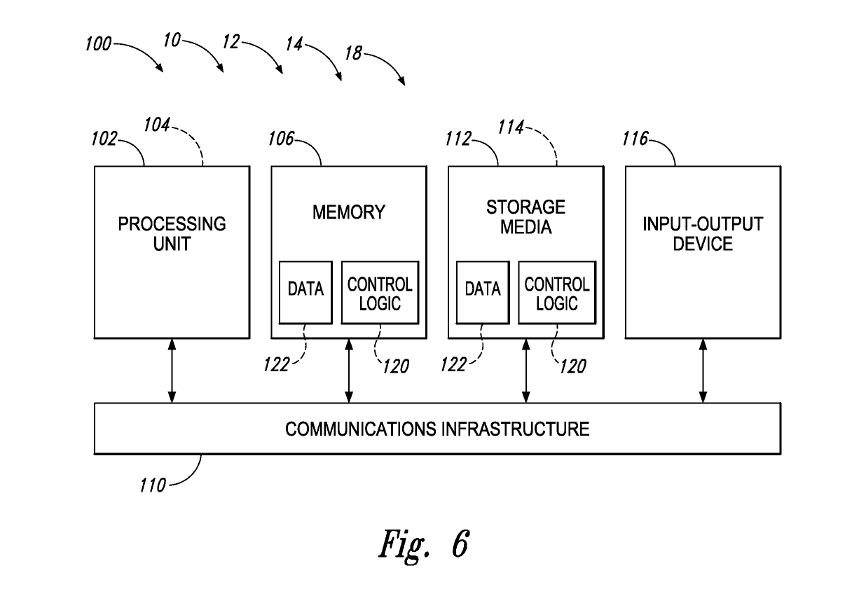

FIG. 6 schematically represents a computing device 100 that may be used to implement and/or instantiate the methods, components, and features described herein. Each of the resource server 10, the resource client device 12, the user device 14, and the control device 18 is an example of the computing device 100. The computing device 100 includes a processing unit 102 operatively coupled to a computer-readable memory 106 by a communications infrastructure 110. The processing unit 102 may include one or more computer processors 104 and may include a distributed group of computer processors 104. The processing unit 102 may include, or be implemented on, programmable, reconfigurable, and/or dedicated hardware such as field-programmable gate arrays, digital signal processors, and/or application specific integrated circuits.

The computing device 100 also may include a computer-readable storage media assemblage 112 that is operatively coupled to the processing unit 102 and/or the computer-readable memory 106, e.g., by communications infrastructure 110. The computer-readable storage media assemblage 112 may include one or more non-transitory computer-readable storage media 114 and may include a distributed group of non-transitory computer-readable storage media 114. The computer-readable memory 106, the computer-readable storage media assemblage 112, and the non-transitory computer-readable media 114 are each computer readable media. Computer-readable media are tangible and are not merely transitory signals.

The communications infrastructure 110 may include a local data bus, a communication interface, and/or a network interface (e.g., a personal-area network interface, a local-area network interface, a wide-area network interface, and/or an Internet interface). The communications infrastructure 110 may be configured to transmit and/or to receive signals, such as electrical, electromagnetic, optical, and/or acoustic signals.

The computing device 100 may include one or more input-output devices 116 operatively coupled to the processing unit 102, the computer-readable memory 106, and/or the computer-readable storage media assemblage 112. Input-output devices 116 may be configured for visual, audio, and/or tactile input and/or output from or to the user 16. Each input-output device 116 independently may be configured for only input, only output, primarily input, primarily output, and/or a combination of input and output. Examples of input-output devices 116 include monitors (e.g., video monitor), displays (e.g., alphanumeric displays, lamps, and/or LEDs), keyboards, pointing devices (e.g., mice), touch screens, speakers, buzzers, and controls (e.g., buttons, knobs, etc.).

The computing device 100 may include a distributed group of components, which each may be interconnected directly or indirectly. Thus, the computing device 100 may include one or more processing units 102, computer-readable memories 106, computer-readable storage media assemblages 112, and/or input-output devices 116.

One or both of the computer-readable memory 106 and the computer-readable storage media assemblage 112 include control logic 120 and/or data 122. Control logic 120 (which may also be referred to as software, firmware, gateware, and/or hardware) may include instructions and/or information that, when executed by the processing unit 102, cause the computing device 100 to perform one or more of the methods described herein. Control logic 120 and/or data 122 may include applications (e.g., a control application), resources, access controls, and/or associated information.

Where the resource server 10, the resource client device 12, the user device 14, and/or the control device 18 are described as performing one or more functions, the respective device is configured, e.g., programmed, to perform the function(s). The respective device may include one or more programs, modules, and/or components configured, e.g., programmed, to perform the function(s) when the programs, modules, and/or components are executed by the processing unit 102 or otherwise operated by the computing device 100. The control logic 120 and/or data 122 may include instructions and/or information corresponding to the programs, modules, and/or components.

Examples of inventive subject matter according to the present disclosure are described in the following enumerated paragraphs.

A1. A method executed by a resource client device, the method comprising:

(a) receiving, from a user via a first communication channel, an alternate address to communicate with the user via an alternate communication channel;

(b) sending a registration request via a second communication channel to a resource server, wherein the registration request includes the alternate address and a unique client device identifier associated with the resource client device;

(c) receiving from the user via the first communication channel a passcode generated by the resource server and sent to the user at the alternate address via the alternate communication channel;

(d) sending a verification request via the second communication channel to the resource server, wherein the verification request includes the passcode; and

(e) receiving from the resource server an access token, after the (d) sending the verification request.

A2. The method of paragraph A1, wherein the unique client device identifier includes a unique component and optionally a recognizable component, wherein the unique component includes at least one of a UUID and a cryptographically-secure random number, and optionally wherein the recognizable component includes at least one of a MAC address of the resource client device and a URI of the resource client device.

A3. The method of any of paragraphs A1-A2, wherein the (a) receiving is receiving the alternate address indirectly from the user via a user device.

A3.1. The method of paragraph A3, wherein the user device is programmed to communicate with the resource client device via the first communication channel.

A3.2. The method of any of paragraphs A3-A3.1, wherein the (a) receiving includes receiving a unique user device identifier from the user device.

A3.2.1. The method of paragraph A3.2, wherein the unique user device identifier includes a unique component and optionally a recognizable component, wherein the unique component includes at least one of a UUID and a cryptographically-secure random number, and optionally wherein the recognizable component includes at least one of a/the MAC address of the resource client device and a/the URI of the resource client device.

A3.3. The method of any of paragraphs A3-A3.2.1, wherein the (c) receiving includes receiving a/the unique user device identifier from the user device.

A3.3.1. The method of paragraph A3.3, wherein the unique user device identifier includes a/the unique component and optionally a/the recognizable component, wherein the unique component includes at least one of a UUID and a cryptographically-secure random number, and optionally wherein the recognizable component includes at least one of a/the MAC address of the resource client device and a/the URI of the resource client device.

A4. The method of any of paragraphs A1-A3.3.1, wherein the first communication channel is a local communication channel.

A4.1. The method of paragraph A4, wherein the first communication channel is a local area network, a personal area network, and/or a peer-to-peer network.

A4.2. The method of any of paragraphs A4-A4.1, wherein the first communication channel is a short-range wireless communication channel, optionally that uses a Bluetooth protocol or a NFC protocol.

A4.3. The method of any of paragraphs A4-A4.1, wherein the first communication channel is a direct wired communication channel.

A5. The method of any of paragraphs A1-A4.3, wherein the first communication channel is configured for secure communications.

A6. The method of any of paragraphs A1-A5, wherein the first communication channel is an encrypted communication channel, optionally a communication channel employing a TLS protocol.

A7. The method of any of paragraphs A1-A6, wherein the first communication channel is a communication channel between the resource client device and a/the user device.

A8. The method of any of paragraphs A1-A7, further comprising establishing the first communication channel between the resource client device and a/the user device, prior to the (a) receiving.

A8.1. The method of paragraph A8, further comprising, before establishing the first communication channel, pairing the resource client device and the user device such that the resource client device and the user device are configured to establish the first communication channel without user intervention.

A8.2. The method of any of paragraphs A8-A8.1, further comprising, upon establishing the first communication channel, requesting, via the first communication channel, the alternate address from the user, optionally provided that the resource client device is in an unmanaged state or provided that the user device is not authenticated by the resource client device.

A9. The method of any of paragraphs A1-A8.2, wherein the second communication channel is a network communication channel.

A9.1. The method of paragraph A9, wherein the second communication channel is at least one of an Internet link and a wide-area network.

A10. The method of any of paragraphs A1-A9.1, wherein the second communication channel is configured for secure communications.

A11. The method of any of paragraphs A1-A10, wherein the second communication channel is an encrypted communication channel, optionally a communication channel employing a TLS protocol.

A12. The method of any of paragraphs A1-A11, wherein the second communication channel is a communication channel between the resource client device and the resource server.

A13. The method of any of paragraphs A1-A12, further comprising establishing the second communication channel between the resource client device and the resource server.

A13.1. The method of paragraph A13, wherein the establishing the second communication channel includes forming a communication session that is restricted to communication between the resource client device and the resource server, and optionally wherein the communication session lasts for the (b) sending the registration request and the (d) sending the verification request.

A13.2. The method of any of paragraphs A13-A13.1, wherein the establishing the second communication channel is performed before the (b) sending the registration request.

A14. The method of any of paragraphs A1-A13.2, wherein the passcode is at least one of an alphanumeric code, a CAPTCHA challenge, and a receipt.

A15. The method of any of paragraphs A1-A14, wherein the passcode is received by the user in a text message, an SMS message, a MMS message, an email message, an instant message, and/or a voice message.

A16. The method of any of paragraphs A1-A15, wherein the alternate communication channel includes a text message protocol, an email protocol, an instant messaging protocol, a telephony protocol, and/or a hypertext transfer protocol.

A17. The method of any of paragraphs A1-A16, wherein the (d) sending the verification request includes sending the unique client device identifier.

A18. The method of any of paragraphs A1-A17, wherein the verification request includes the unique client device identifier.

A19. The method of any of paragraphs A1-A18, wherein the access token is a cryptographic key.

A20. The method of any of paragraphs A1-A19, wherein the resource client device is programmed to accept resource requests from a/the user device only if the resource request includes a user access token.

A21. The method of any of paragraphs A1-A20, wherein the access token is associated with the unique client device identifier by the resource server.

A22. The method of any of paragraphs A1-A21, further comprising sending a registration success message via the first communication channel.

A22.1. The method of paragraph A22, wherein the registration success message includes the access token.

A22.2. The method of any of paragraphs A22-A22.1, wherein the sending the registration success message includes sending the registration success message to at least one of the user and a/the user device.

A22.3. The method of any of paragraphs A22-A22.2, wherein the registration success message includes a/the user access token generated, retrieved, and/or received by the resource client device.

A22.3.1. The method of paragraph A22.3, wherein the user access token is associated with a/the user device and the access token.

A22.3.2. The method of any of paragraphs A22.3-A22.3.1, wherein the user access token is the access token.

A23. The method of any of paragraphs A1-A22.3.2, further comprising sending a resource request to the resource server that includes the access token and optionally the unique client device identifier.

A24. The method of any of paragraphs A1-A23, further comprising sending a/the resource request to the resource server that includes a message authentication code based on the access token and optionally the unique client device identifier.

A25. The method of any of paragraphs A1-A24, further comprising sending a/the resource request to the resource server that is encrypted with a key based on the access token.

A25.1. The method of paragraph A25, wherein the resource request includes the unique client device identifier in plaintext.

A26. A method executed by a resource client device, the method comprising:

receiving, at a resource client device, a request to register the resource client device with a resource server, wherein the request to register includes an alternate address to communicate with a user via an alternate communication channel;

sending, from the resource client device, a relay request to register to the resource server, wherein the relay request to register includes the alternate address and a unique client device identifier associated with the resource client device;

receiving, at the resource client device, a passcode from the user that was received by the user at the alternate address via the alternate communication channel from the resource server;

sending, from the resource client device, a verification message to the resource server, wherein the verification message includes the passcode and the unique client device identifier;

after sending the verification message, receiving, at the resource client device, an access token from the resource server;

A27. The method of paragraph A26, further comprising, storing the access token in the resource client device, in response to receiving the access token.

A28. The method of any of paragraphs A26-A27, further comprising, generating, in response to receiving the access token, a user access token and sending the user access token to a user device that received the passcode from the user and that sent the passcode to the resource client device.

A29. The method of any of paragraphs A26-A28, further comprising sending, from the resource client device, a resource request to the resource server, wherein the resource request includes the access token and the unique client device identifier.

A30. A method executed by a resource client device, the method comprising:

receiving, from a user device via a local communication channel, a passcode generated by a resource server and sent to the user device via an alternate communication channel;

sending a verification request via a network communication channel to the resource server, wherein the verification request includes the passcode and a unique client device identifier associated with the resource client device; and

receiving from the resource server an access token in response to sending the verification request.

A31. The method of paragraph A30, wherein the unique client device identifier includes a unique component and optionally a recognizable component, wherein the unique component includes at least one of a UUID and a cryptographically-secure random number, and optionally wherein the recognizable component includes at least one of a MAC address of the resource client device and a URI of the resource client device.

A32. The method of any of paragraphs A30-A31, wherein the local communication channel is a local area network, a personal area network, and/or a peer-to-peer network.

A33. The method of any of paragraphs A30-A32, wherein the local communication channel is a short-range wireless communication channel, optionally that uses a Bluetooth protocol or a NFC protocol.

A34. The method of any of paragraphs A30-A32, wherein the local communication channel is a direct wired communication channel.

A35. The method of any of paragraphs A30-A34, wherein the local communication channel is configured for secure communications.

A36. The method of any of paragraphs A30-A35, wherein the local communication channel is an encrypted communication channel, optionally a communication channel employing a TLS protocol.

A37. The method of any of paragraphs A30-A36, further comprising establishing the local communication channel between the resource client device and the user device, prior to receiving the passcode.

A37.1. The method of paragraph A37, further comprising, before establishing the local communication channel, pairing the resource client device and the user device such that the resource client device and the user device are configured to establish the local communication channel without user intervention.

A38. The method of any of paragraphs A30-37.1, wherein the network communication channel is at least one of an Internet link and a wide-area network.

A39. The method of any of paragraphs A30-A38, wherein the network communication channel is configured for secure communications.

A40. The method of any of paragraphs A30-A39, wherein the network communication channel is an encrypted communication channel, optionally a communication channel employing a TLS protocol.

A41. The method of any of paragraphs A30-A40, further comprising establishing the network communication channel between the resource client device and the resource server.

A41.1. The method of paragraph A41, wherein the establishing the network communication channel includes forming a communication session that is restricted to communication between the resource client device and the resource server, and optionally wherein the communication session lasts for the sending the verification request and the receiving the access token.

A41.2. The method of any of paragraphs A41-A41.1, wherein the establishing the network communication channel is performed before the sending the verification request.

A42. The method of any of paragraphs A30-A41.2, wherein the passcode is at least one of an alphanumeric code, a CAPTCHA challenge, and a receipt.

A43. The method of any of paragraphs A30-A42, wherein the passcode is received by the user device in a text message, an SMS message, a MMS message, an email message, an instant message, and/or a voice message.

A44. The method of any of paragraphs A30-A43, wherein the access token is a cryptographic key.

A45. The method of any of paragraphs A30-A44, wherein the resource client device is programmed to accept resource requests from the user device only if the resource request includes a user access token.

A46. The method of any of paragraphs A30-A45, wherein the access token is associated with the unique client device identifier by the resource server.

A47. The method of any of paragraphs A30-A46, further comprising sending a registration success message via the local communication channel.

A47.1. The method of paragraph A47, wherein the registration success message includes the access token.

A47.2. The method of any of paragraphs A47-A47.1, wherein the sending the registration success message includes sending the registration success message to a/the user.

A47.3. The method of any of paragraphs A47-A47.2, wherein the registration success message includes a/the user access token generated, retrieved, and/or received by the resource client device.

A47.3.1. The method of paragraph A47.3, wherein the user access token is associated with the user device and the access token.

A47.3.2. The method of any of paragraphs A47.3-A47.3.1, wherein the user access token is the access token.

A48. The method of any of paragraphs A30-A47.3.2, further comprising sending a resource request to the resource server that includes the access token and optionally the unique client device identifier.

A49. The method of any of paragraphs A30-A48, further comprising sending a/the resource request to the resource server that includes a message authentication code based on the access token and optionally the unique client device identifier.

A50. The method of any of paragraphs A30-A49, further comprising sending a/the resource request to the resource server that is encrypted with a key based on the access token.

A50.1. The method of paragraph A50, wherein the resource request includes the unique client device identifier in plaintext.

A51. A resource client device that includes a computer processor and computer-readable memory, wherein the resource client device is programmed to perform any of the methods of paragraphs A1-A50.1.

B1. A method executed by a resource server, the method comprising:

(a) receiving a registration request from a resource client device via a network communication channel, wherein the registration request includes an alternate address to communicate with a user via an alternate communication channel and includes a unique client device identifier associated with resource client device;

(b) sending a passcode to the user at the alternate address via the alternate communication channel;

(c) receiving a verification request via the network communication channel from the resource client device, wherein the verification request includes the passcode; and

(d) associating an access token with the unique client device identifier;

(e) sending the access token to the resource client device via the network communication channel, after the (c) receiving the verification request that includes the passcode.

B2. The method of paragraph B1, wherein the unique client device identifier includes a unique component and optionally a recognizable component, wherein the unique component includes at least one of a UUID and a cryptographically-secure random number, and optionally wherein the recognizable component includes at least one of a MAC address of the resource client device and a URI of the resource client device.

B3. The method of any of paragraphs B1-B2, further comprising associating the alternate address with the unique client device identifier.

B4. The method of any of paragraphs B1-B3, further comprising recording the unique client device identifier in response to the (a) receiving the registration request and/or the (c) receiving the verification request.

B5. The method of any of paragraphs B1-B4, wherein the network communication channel is at least one of an Internet link and a wide-area network.

B6. The method of any of paragraphs B1-B5, wherein the network communication channel is configured for secure communications.

B7. The method of any of paragraphs B1-B6, wherein the network communication channel is an encrypted communication channel, optionally a communication channel employing a TLS protocol.

B8. The method of any of paragraphs B1-B7, wherein the network communication channel is a communication channel between the resource client device and the resource server.

B9. The method of any of paragraphs B1-B8, further comprising establishing the network communication channel between the resource client device and the resource server.

B9.1. The method of paragraph B9, wherein the establishing the network communication channel includes forming a communication session that is restricted to communication between the resource client device and the resource server, and optionally wherein the communication session lasts for the (a) receiving the registration request and the (c) receiving the verification request.

B9.2. The method of any of paragraphs B9-B9.1, wherein the establishing the network communication channel is performed before the (a) receiving the registration request.

B10. The method of any of paragraphs B1-B9.2, further comprising verifying that the passcode received in the (c) receiving matches the passcode sent in the (b) sending.

B11. The method of any of paragraphs B1-B10, further comprising generating the passcode and optionally associating the passcode with the unique client device identifier.

B12. The method of any of paragraphs B1-B11, wherein the passcode is at least one of an alphanumeric code, a CAPTCHA challenge, and a receipt.

B13. The method of any of paragraphs B1-B12, wherein the (b) sending includes sending the user a message that indicates the passcode, wherein the message is one or more of a text message, an SMS message, a MMS message, an email message, an instant message, and a voice message.

B14. The method of any of paragraphs B1-B13, wherein the alternate communication channel includes a text message protocol, an email protocol, an instant messaging protocol, a telephony protocol, and/or a hypertext transfer protocol.

B15. The method of any of paragraphs B1-B14, wherein the (c) receiving the verification request includes receiving the unique client device identifier.

B16. The method of any of paragraphs B1-B15, wherein the verification request includes the unique client device identifier.

B17. The method of any of paragraphs B1-B16, further comprising generating the access token, in response to the (c) receiving the verification request that includes the passcode.

B18. The method of any of paragraphs B1-B17, wherein the access token is a cryptographic key.

B19. The method of any of paragraphs B1-B18, wherein the resource server is programmed to accept resource requests from the resource client device only if the resource request includes the access token.

B20. The method of any of paragraphs B1-B19, further comprising receiving a/the resource request from the resource client device that includes the access token and optionally the unique client device identifier.

B21. The method of any of paragraphs B1-B20, further comprising receiving a/the resource request from the resource client device that includes a message authentication code based on the access token and optionally the unique client device identifier.

B22. The method of any of paragraphs B1-B21, further comprising receiving a/the resource request from the resource client device that is encrypted with a key based on the access token.

B22.1. The method of paragraph B22, wherein the resource request includes the unique client device identifier in plaintext.

B23. A resource server that includes a processor and computer-readable memory, wherein the resource server is programmed to perform any of the methods of paragraphs B1-B22.1.

C1. A method executed by a user device, the method comprising:

(a) sending to a resource client device, via a local communication channel, an alternate address to communicate with a user via an alternate communication channel;

(b) receiving from the user a passcode generated by a resource server that received the alternate address from the resource client device, wherein the passcode was sent to the user at the alternate address via the alternate communication channel;

(c) providing the passcode to the resource client device; and

(d) receiving a user access token from the resource client device in response to verification of the passcode by the resource server.

C2. The method of paragraph C1, further comprising receiving the alternate address from the user prior to the (a) sending to the resource client device the alternate address.

C3. The method of any of paragraphs C1-C2, wherein the (a) sending includes sending a unique user device identifier to the resource client device.

C3.1. The method of paragraph C3, wherein the unique user device identifier includes a unique component and optionally a recognizable component, wherein the unique component includes at least one of a UUID and a cryptographically-secure random number, and optionally wherein the recognizable component includes at least one of a MAC address of the resource client device and a URI of the resource client device.

C4. The method of any of paragraphs C1-C3.1, wherein the (c) providing includes providing a/the unique user device identifier to the resource client device.

C4.1. The method of paragraph C4, wherein the unique user device identifier includes a/the unique component and optionally a/the recognizable component, wherein the unique component includes at least one of a UUID and a cryptographically-secure random number, and optionally wherein the recognizable component includes at least one of a/the MAC address of the resource client device and a/the URI of the resource client device.

C5. The method of any of paragraphs C1-C4.1, wherein the local communication channel is a local area network, a personal area network, and/or a peer-to-peer network.

C5.1. The method of paragraph C5, wherein the local communication channel is a short-range wireless communication channel, optionally that uses a Bluetooth protocol or a NFC protocol.

C5.2. The method of paragraph C5, wherein the local communication channel is a direct wired communication channel.

C6. The method of any of paragraphs C1-C5.2, wherein the local communication channel is configured for secure communications.

C7. The method of any of paragraphs C1-C6, wherein the local communication channel is an encrypted communication channel, optionally a communication channel employing a TLS protocol.

C8. The method of any of paragraphs C1-C7, wherein the local communication channel is a communication channel between the user device and the resource client device.

C9. The method of any of paragraphs C1-C8, further comprising establishing the local communication channel between the user device and the resource client device, prior to the (a) sending.

C9.1. The method of paragraph C9, further comprising, before establishing the local communication channel, pairing the resource client device and the user device such that the resource client device and the user device are programmed to establish the local communication channel without user intervention.

C9.2. The method of any of paragraphs C9-C9.1, wherein the (a) sending is performed in response to establishing the local communication channel.

C10. The method of any of paragraphs C1-C9.2, wherein the passcode is at least one of an alphanumeric code, a CAPTCHA challenge, and a receipt.

C11. The method of any of paragraphs C1-C10, wherein the passcode is received by the user in a text message, an SMS message, a MMS message, an email message, an instant message, and/or a voice message.

C12. The method of any of paragraphs C1-C11, wherein the alternate communication channel includes a text message protocol, an email protocol, an instant messaging protocol, a telephony protocol, and/or a hypertext transfer protocol.

C13. The method of any of paragraphs C1-C12, wherein the user access token is a cryptographic key.

C14. The method of any of paragraphs C1-C13, wherein the resource client device is programmed to accept resource requests from the user device only if the resource request includes the user access token.

C15. The method of any of paragraphs C1-C14, further comprising sending a/the resource request to the resource client device that includes the user access token and optionally a/the unique user device identifier.

C16. The method of any of paragraphs C1-C15, further comprising sending a/the resource request to the resource client device that includes a message authentication code based on the user access token and optionally a/the unique user device identifier.

C17. The method of any of paragraphs C1-C16, further comprising sending a/the resource request to the resource client device that is encrypted with a key based on the user access token.

C17.1. The method of paragraph C17, wherein the resource request includes the unique user device identifier in plaintext.

C18. A user device that includes a processor and computer-readable memory, wherein the user device is programmed to perform any of the methods of paragraphs C1-C17.1.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, the phrases “at least one of” and “one or more of,” in reference to a list of more than one entity, means any one or more of the entities in the list of entities, and is not limited to at least one of each and every entity specifically listed within the list of entities. For example, “at least one of A and B” (or, equivalently, “at least one of A or B,” or, equivalently, “at least one of A and/or B”) may refer to A alone, B alone, or the combination of A and B.

As used herein, the singular forms “a”, “an” and “the” may be intended to include the plural forms as well, unless the context clearly indicates otherwise.

The various disclosed elements of systems and steps of methods disclosed herein are not required of all systems and methods according to the present disclosure, and the present disclosure includes all novel and non-obvious combinations and subcombinations of the various elements and steps disclosed herein. Moreover, any of the various elements and steps, or any combination of the various elements and/or steps, disclosed herein may define independent inventive subject matter that is separate and apart from the whole of a disclosed system or method. Accordingly, such inventive subject matter is not required to be associated with the specific systems and methods that are expressly disclosed herein, and such inventive subject matter may find utility in systems and/or methods that are not expressly disclosed herein.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A method executed by a resource client device, the method comprising:
(a) receiving, from a user via a local communication channel, an alternate address to communicate with the user via an alternate communication channel;
(b) sending a registration request via a network communication channel to a resource server, wherein the registration request includes the alternate address and a unique client device identifier associated with the resource client device;
(c) receiving from the user via the local communication channel a passcode generated by the resource server and sent to the user at the alternate address via the alternate communication channel;
(d) sending a verification request via the network communication channel to the resource server, wherein the verification request includes the passcode; and
(e) receiving from the resource server an access token, after the (d) sending the verification request.

2. The method of claim 1, further comprising sending a registration success message via the local communication channel to a user device associated with the user, wherein the registration success message includes a user access token retrieved by the resource client device.

3. The method of claim 2, wherein the user access token is the access token.

4. The method of claim 2, wherein the resource client device is programmed to accept resource requests from the user device only if the resource request includes the user access token.

5. The method of claim 1, further comprising sending a resource request to the resource server that includes the access token and the unique client device identifier.

6. The method of claim 1, wherein the (b) sending the registration request includes sending at least one of a UUID (universally unique identifier) and a cryptographically-secure random number as part of the unique client device identifier.

7. The method of claim 6, wherein the (b) sending the registration request includes sending at least one of a MAC (media access control) address of the resource client device and a URI (uniform resource identifier) of the resource client device as part of the unique client device identifier.

8. The method of claim 1, further comprising establishing the local communication channel between the resource client device and a user device associated with the user, prior to the (a) receiving.

9. The method of claim 1, wherein the (b) sending and the (d) sending include employing a TLS (transport layer security) protocol with the network communication channel.

10. A resource client device that includes a computer processor and computer-readable memory, wherein the resource client device is programmed to:
(a) receive, from a user via a local communication channel, an alternate address to communicate with the user via an alternate communication channel;
(b) send a registration request via a network communication channel to a resource server, wherein the registration request includes the alternate address and a unique client device identifier associated with the resource client device;
(c) receive from the user via the local communication channel a passcode generated by the resource server and sent to the user at the alternate address via the alternate communication channel;
(d) send a verification request via the network communication channel to the resource server, wherein the verification request includes the passcode; and
(e) receive from the resource server an access token, after the verification request is sent.

11. The resource client device of claim 10, further programmed to establish the local communication channel configured for secure communications between the resource client device and a user device associated with the user.

12. The resource client device of claim 10, further programmed to establish the network communication channel employing a TLS protocol between the resource client device and the resource server.

13. The resource client device of claim 10, further programmed to send resource requests that include the access token to the resource server.

14. The resource client device of claim 10, further programmed to accept resource requests from a user device that is associated with the user only if the resource request includes a user access token.

15. A resource client device that includes a computer processor and computer-readable memory, wherein the resource client device is programmed to:
(a) receive, from a user device via a local communication channel, a passcode generated by a resource server and sent to the user device via an alternate communication channel;
(b) send a verification request via a network communication channel to the resource server, wherein the verification request includes the passcode and a unique client device identifier associated with the resource client device; and
(c) receive from the resource server an access token in response to sending the verification request.

16. The resource client device of claim 15, wherein the unique client device identifier includes at least one of a UUID and a cryptographically-secure random number.

17. The resource client device of claim 15, wherein the unique client device identifier includes at least one of a MAC address of the resource client device and a URI of the resource client device.

18. The resource client device of claim 15, further programmed to establish the network communication channel employing a TLS protocol between the resource client device and the resource server.

19. The resource client device of claim 15, further programmed to send resource requests that include the access token and the unique client device identifier to the resource server.

20. The resource client device of claim 15, wherein the passcode is a purchase receipt representing a subscription to services of the resource server.
